(19) United States
(12) Patent Application Publication
(10) Pub. No.: US 2022/0172079 A1
(43) Pub. Date: Jun. 2, 2022

(54) BUILDING CHATBOTS FOR EXTERNAL KNOWLEDGE SOURCES

(71) Applicant: International Business Machines Corporation, Armonk, NY (US)

(72) Inventors: Piotr Kalandyk, Zielonki (PL); Hubert Kompanowski, Krakow (PL); Grzegorz Piotr Szczepanik, Krakow (PL); Pawel Tadeusz Januszek, Krakow (PL)

(21) Appl. No.: 17/109,186

(22) Filed: Dec. 2, 2020

(51) Int. Cl. G06N 5/04; G06N 5/02; H04L 12/58; G06F 40/205

(52) U.S. Cl. CPC G06N 5/04; G06F 40/205; H04L 51/02; G06N 5/022

(57) ABSTRACT

Building a chatbot using an external knowledge base to eliminate the need for after-build testing by receiving a plurality of problem-solution records from the external knowledge base, classifying the plurality of problem-solution records according to a set of subject categories, converting, based on the set of categories, the plurality of problem-solution records into a plurality of chatbot intent-entity records, and building, using the plurality of chatbot intent-entity records, the chatbot.

### BACKGROUND

The present invention relates generally to the field of computer software, and more particularly to personal automated software.

The Wikipedia entry for “chatbot” (as of Oct. 21, 2020) states, in part, as follows: “A chatbot is a software application used to conduct an on-line chat conversation via text or text-to-speech, in lieu of providing direct contact with a live human agent. Designed to convincingly simulate the way a human would behave as a conversational partner, chatbot systems typically require continuous tuning and testing, and many in production remain unable to adequately converse or pass the industry standard Turing test. The term “ChatterBot” was originally coined by Michael Mauldin (creator of the first Verbot) in 1994 to describe these conversational programs. Chatbots are used in dialog systems for various purposes including customer service, request routing, or for information gathering. While some chatbot applications use extensive word-classification processes, natural language processors, and sophisticated AI, others simply scan for general keywords and generate responses using common phrases obtained from an associated library or database. Most chatbots are accessed on-line via website popups or through virtual assistants. They can be classified into usage categories that include: commerce (e-commerce via chat), education, entertainment, finance, health, news, and productivity.”

Further with regard to an understanding of what chatbots are, a chatbot is a service which answers user's question. Typically, a given chatbot design can use different user interface displays/sounds, or, to put it another way, a single chatbot can be used with multiple different chatbot frontends. A chatbot may be deployed in a variety of ways, such as through web page or through a “fat client.” In development phase a chatbot typically includes data indicative of different intents, different entities and different historical conversation dialogs. These types of data are compiled into one service/program block.

The Wikipedia entry for “knowledge base” (as of Oct. 21, 2020) states, in part, as follows: “A knowledge base (KB) is a technology used to store complex structured and unstructured information used by a computer system. The initial use of the term was in connection with expert systems which were the first knowledge-based systems. The original use of the term knowledge-base was to describe one of the two sub-systems of a knowledge-based system. A knowledge-based system consists of a knowledge-base that represents facts about the world and an inference engine that can reason about those facts and use rules and other forms of logic to deduce new facts or highlight inconsistencies. The term “knowledge-base” was coined to distinguish this form of knowledge store from the more common and widely used term database. At the time (the 1970s) virtually all large management information systems stored their data in some type of hierarchical or relational database. At this point in the history of information technology, the distinction between a database and a knowledge base was clear and unambiguous.”

INTERNAL VERSUS EXTERNAL CHATBOT SOURCES: It is known that chatbots can use: (i) information internal to the chatbot in order to obtain info useful in chatting; and (ii) information external to the chatbot in order to obtain info useful in chatting. The current understanding in the art regarding this internal versus external distinction will now be discussed. Information is considered to be external to the chatbot if the information is received by the chatbot from component(s) that are separate from the chatbot from an architectural standpoint, which is to components and/or information stored at the component(s) that are not required for the chatbot to run its basic logic, but rather to enrich chat conversations with various users. The distinction between internal and external correlates to the difference between built-in and additional content. The built-in is the core of chatbot and typically is has been purposefully designed/created in that way. This is distinguishable from external information source(s) and/or component(s) which the chatbot may reach by communicating with these sources that are not part of the chatbot proper. Internal sources are typically designed to work with the chatbot. External source(s) typically have been intended and/or designed for use with a chatbot. External means is not collected by the chatbot processes instructed and implemented by the chatbot itself.

CHATBOT INTENT-ENTITY RECORDS: are data sets that include information indicative of: (i) a group of natural language questions (NLQs) that are believed to have a similar meaning and request that similar information is provided in response; and (ii) group of similar words. phrases and synonyms which are used to describe the same thing. Item (ii) is useful in determining which NLQs (for example, NLQs derived from questions received from users historically) belong in the group defined by item (i) in the foregoing list. This can be instrumental when translating a chatbot answer, within scope, concerning the same topic or knowledge base.

### SUMMARY

According to an aspect of the present invention, there is a method, computer program product and/or system for use with a chatbot and a knowledge base that is external to the chatbot that performs the following operations (not necessarily in the following order): (i) receives, from the knowledge base, a plurality of problem-solution data sets with each problem-solution data set including information indicative of at least a problem and an associated solution that was attempted for the purpose of resolving the problem; (ii) receives a classification system definition data set (CSDDS) that includes information indicative of a plurality of categories and/or sub-categories and relationships between the categories and/or sub-categories to define a classification system; (iii) classifies, by machine logic, the plurality of problem-solution data sets according to the classification system to obtain a plurality of classified problem-solution data sets; (iv) converts, by machine logic, the plurality of classified problem-solution records into a plurality of chatbot intent-entity records; and (v) inserts the plurality of chatbot intent-entity records into the chatbot type computer program to build and/or refine the chatbot, which chatbot is programmed and/or structured to chat with users about the problems included in the plurality of problem-solution data sets using the chatbot intent-entity records.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a system diagram view generated by the first embodiment system; and

FIG. 5 is a flowchart showing a second embodiment of a method according to the present invention.

### DETAILED DESCRIPTION

Some embodiments of the present invention are directed to building a chatbot using an external knowledge base to eliminate the need for after-build testing by receiving a plurality of problem-solution records from the external knowledge base, classifying the plurality of problem-solution records according to a set of subject categories, converting, based on the set of categories, the plurality of problem-solution records into a plurality of chatbot intent-entity records, and building, using the plurality of chatbot intent-entity records, the chatbot. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

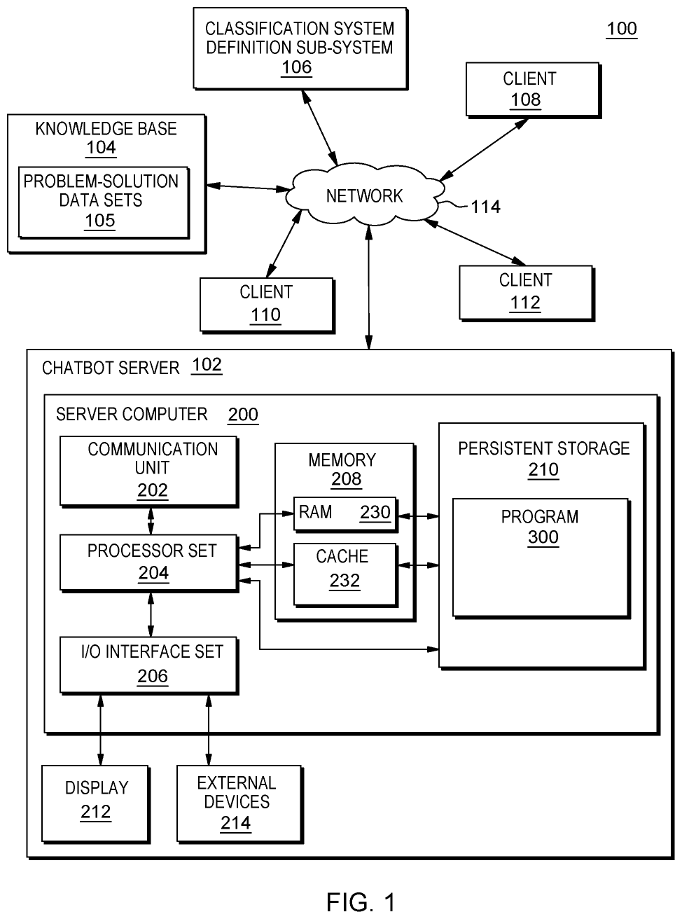

As shown in FIG. 1, networked computers system 100 is an embodiment of a hardware and software environment for use with various embodiments of the present invention. Networked computers system 100 includes: chatbot server 102; knowledge base 104, problem-solution data sets 105, classification system definition sub-system 106, client subsystems 108, 110, 112; and communication network 114. Chatbot server 102 includes: server computer 200; communication unit 202; processor set 204; input/output (I/O) interface set 206; memory 208; persistent storage 210; display 212; external device(s) 214; random access memory (RAM) 230; cache 232; and program 300.

Chatbot server 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Chatbot server 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Chatbot server 102 is shown as a block diagram with many double arrows. These double arrows (no separate reference numerals) represent a communications fabric, which provides communications between various components of chatbot server 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for chatbot server 102; and/or (ii) devices external to chatbot server 102 may be able to provide memory for chatbot server 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to chatbot server 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

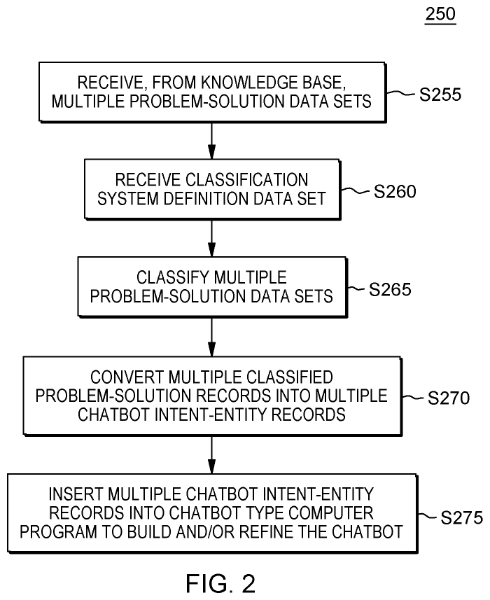

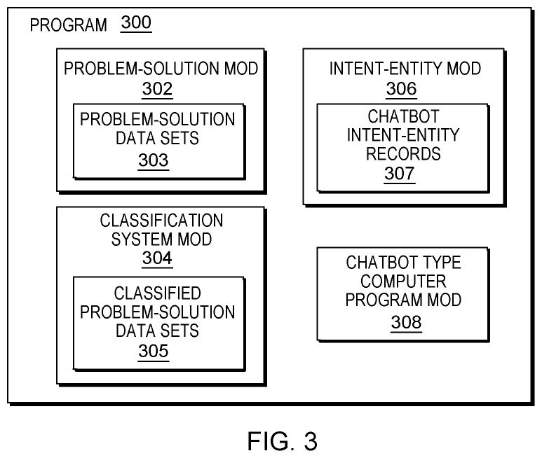

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation 5255, where problem-solution module (“mod”) 302 receives multiple problem-solution data sets 303, through communication network 114 and from knowledge base 104 (see, also, problem-solution data sets 105 as stored within the knowledge base). Knowledge base 104 is external to the chatbot (see discussion of internal versus external chatbot sources, above, in the Background section). Each problem-solution data set includes information indicative of at least a problem and an associated solution that was attempted for the purpose of resolving the problem.

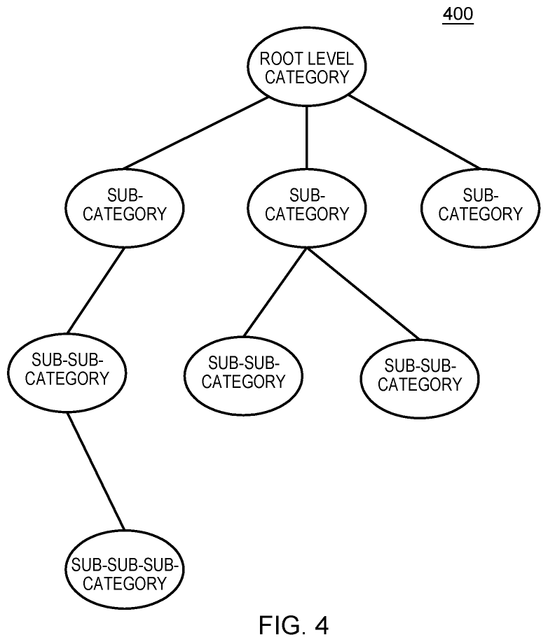

Processing proceeds to operation 5260, where classification system mod 304 receives a classification system definition data set (CSDDS, not separately shown in the Figures), through communication network 114 and from classification system definition sub-system 106. The CSDDS includes information indicative of a set of categories and/or sub-categories and relationships between the categories and/or sub-categories to define a classification system (see CSDDS category hierarchical graph 400 in FIG. 4).

Processing proceeds to operation 5265, where classification system mod 304 classifies multiple problem-solution data sets 303 according to the classification system defined by the CSDDS to obtain a plurality of classified problem-solution data sets 305.

Processing proceeds to operation 5270, where intent-entity mod 306 converts multiple classified problem-solution records 305 into multiple chatbot intent-entity records 307. The type of data included in a chatbot intent-entity record is discussed, above, in the Background section.

Processing proceeds to operation 5275, where chatbot type computer program mod 308 inserts multiple chatbot intent-entity records into the chatbot type computer program 308 to build and/or refine the chatbot. The chatbot is programmed and/or structured to chat with users about the problems included in the plurality of problem-solution data sets using the chatbot intent-entity records.

### III. Further Comments and/or Embodiments

A method according to an embodiment of the present invention for building a chatbot using an external knowledge base to eliminate the need for after-build testing includes the following operations (not necessarily in the following order): (i) receives a plurality of problem-solution records from the external knowledge base; (ii) classifies the plurality of problem-solution records according to a set of subject categories; (iii) converts, based on the set of categories, the plurality of problem-solution records into a plurality of chatbot intent-entity records; (iv) builds, using the plurality of chatbot intent-entity records, the chatbot; (v) the set of subject categories are extracted from the plurality of problem-solution records; (vi) the set of subject categories are stored in a relational database to cross-reference the set of subject categories and the plurality of problem-solution records; and (vii) the conversion includes maintaining the cross-referencing among the set of subject categories and the plurality of chatbot intent-entity records.

Some embodiments of the present invention may include one, or more, of the following operations, features, characteristics and/or advantages: (i) focuses on single chatbot development; and/or (ii) focuses on building chatbot conversations.

Some embodiments of the present invention recognize the following facts, potential problems and/or potential areas for improvement with respect to the current state of the art: (i) the current process of chatbot development is complex and requires the development engineer to perform user question tests and validations in several places: (ii) the first tests development engineers use are those used while creating a conversation dialog in a chatbot development tool; (iii) the next test the development engineer performs, just after the build process, uses external programs such as a chatbot API (application programming interface) client or chatbot target UI (user interface) which merges external knowledge sources; (iv) it is hard to tune the chatbot definitions, since the provided answer often differs between the chatbot tool and the target chatbot UI, using the same user's question; and/or (v) the chatbot's answer confidence level is calculated differently for the same question, since the external source data is added to the chatbot workspace during the build process.

Some embodiments of the present invention may include one, or more, of the following operations, features, characteristics and/or advantages where the idea is to split the development build process of chatbot into the following two parts: (i) import and synchronize external source data structure definitions into a chatbot workspace where: (a) the developer could leverage the chatbot tool to test questions for the source's structure, (b) no additional testing will be needed at the end, (c) speeds up the process, (d) there will be no need to switch context between the chatbot tool and other tools for testing questions, and (e) gives full control to the chatbot developer where all of the data is in one place; and/or (ii) adding the rest of the external logic which does not: (a) impact answers to the chatbot workspace, and (b) impact performing production deployment.

Some embodiments of the present invention may include one, or more, of the following operations, features, characteristics and/or advantages: (i) uses commercially available management software tools; and/or (ii) uses commercially available assistance software tools as a chatbot development tool.

Some embodiments of the present invention may include one, or more, of the following operations, features, characteristics and/or advantages: (i) the management software tool keeps problem solution records grouped into subject categories; (ii) the categories have their synonyms which are converted into chatbot intents and entities during the build process; (iii) the management software tool works together with the assistance software tool; (iv) includes access to internal built version(s) in order to test any developer questions; (v) the management software tool contents will be added to the assistance software tool so the test will be performed as one step, not needing a two-step process, that is, before and after build; (vi) the management software tool output will be added to the assistance software tool output in a first synchronization step, so the test will perform as one; and/or (vii) the final build step will add the rest of the management tool logic and deploy the chatbot on the target environment.

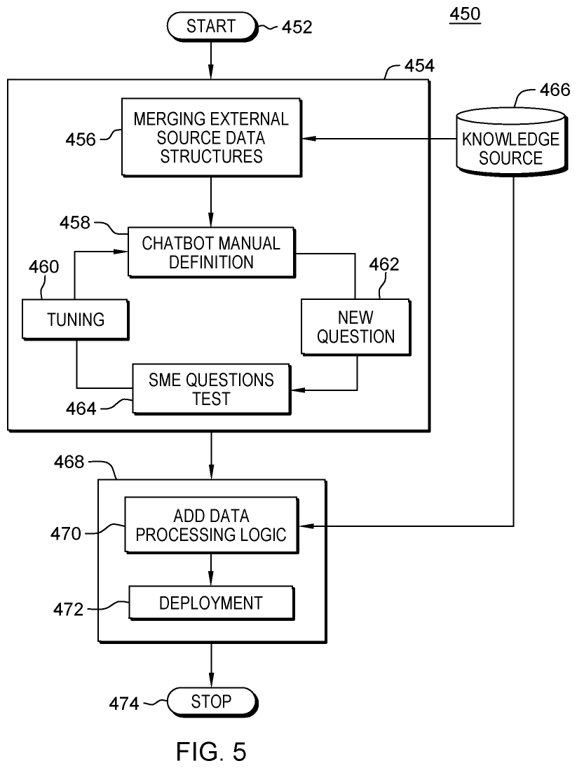

As shown in FIG. 5, flow chart 450 is an embodiment of a method according to the present invention and includes the following operation blocks: start block 452; import/synchronization block 454; merging external source data structures block 456; chatbot manual definition block 458, tuning block 460; new question block 462; SME (subject matter expert) questions test block 464; knowledge source storage block 466; external logic block 468; add data processing logic block 470; deployment block 472; and stop block 474.

As mentioned above, intent-entity records essentially include different ways of wording the same question that has come up repeatedly. Here is a typical example, of a specific question that a user may have entered: “I have to install the latest version of Product A, how to do it?” (this question is called Q1.) An algorithm (called Algorithm A) according to the present invention creates an installation intent with the user question as an example. Next, the intent will be used by conversation dialog which returns instruction for Product A installation, since “Product A” will be recognized as an entity for a sub-dialog condition. Next, the external knowledge database will be imported and merged with the current conversation. The database contains the following records: (i) latest version of Product A is 9.2.15.1->marked as version class; (ii) component versions of known products are listed in http:// . . . ->marked as version class; and (iii) the Product B latest version has bug 1200 which will be solved in version N+2->marked as version class. The merge process adds new version intent with 3 examples which impacts the original installation intent. The Q1 question is routed to the version class and cannot be answered. For these reasons, Algorithm A needs to be redesigned by adding more examples, with install keywords, to the installation intent. The chatbot developer then creates a conversation with a new version of the intent and the three (3) dialogs. Next, the installation intent is added with Q1 question, and several other examples, which routes installation questions to a new dialog 4. All intents do not collide.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

What is claimed is:

1. A computer implemented method (CIM) for use with a chatbot and a knowledge base that is external to the chatbot, the CIM comprising:
receiving, from the knowledge base, a plurality of problem-solution data sets with each problem-solution data set including information indicative of at least a problem and an associated solution that was attempted for the purpose of resolving the problem;
receiving a classification system definition data set (CSDDS) that includes information indicative of a plurality of categories and/or sub-categories and relationships between the categories and/or sub-categories to define a classification system;
classifying, by machine logic, the plurality of problem-solution data sets according to the classification system to obtain a plurality of classified problem-solution data sets;
converting, by machine logic, the plurality of classified problem-solution records into a plurality of chatbot intent-entity records; and
inserting the plurality of chatbot intent-entity records into the chatbot type computer program to build and/or refine the chatbot, which chatbot is programmed and/or structured to chat with users about the problems included in the plurality of problem-solution data sets using the chatbot intent-entity records.

2. The CIM of claim 1 wherein the receipt of the plurality of problem-solution data sets from the knowledge base that is external to the chatbot reduces after-build testing because the knowledge base is external to the chatbot.

3. The CIM of claim 1 wherein the receipt of the CSDDS includes extracting the plurality of categories and/or sub-categories and relationships between the categories and/or sub-categories from the plurality of problem-solution records.

4. The CIM of claim 1 further comprising:
configuring a relational database to store information indicative the plurality of categories and/or sub-categories and relationships between the categories and/or sub-categories;
storing, in the relational database, the plurality of categories and/or sub-categories and relationships between the categories and/or sub-categories; and
cross-referencing, using information stored in the relational data base, the CSDSS with the plurality of problem-solution data sets.

5. The CIM of claim 4 wherein the conversion of the plurality of problem-solution records into the plurality of chatbot intent-entity records includes maintaining the cross-referencing between the following: (i) the plurality of categories and/or sub-categories and relationships between the categories and/or sub-categories, and (ii) the plurality of chatbot intent-entity data sets.

6. The CIM of claim 1 wherein the chatbot type computer program includes:
a user interface module structured and/or programmed to communicate information from and to the users of the chatbot;
a natural language parsing module structured and/or programmed to parse natural language pieces of text received from users during chats; and
a chat control logic module structured and/or programmed to match user inputs to corresponding chatbot intent-entity records and to generate natural language text for chats with users based, at least in part, upon the chatbot intent-entity data sets.

7. A computer program product (CPP) for use with a chatbot and a knowledge base that is external to the chatbot, the CPP comprising:
a set of storage device(s); and
computer code stored collectively in the set of storage device(s), with the computer code including data and instructions to cause a processor(s) set to perform at least the following operations:
receiving, from the knowledge base, a plurality of problem-solution data sets with each problem-solution data set including information indicative of at least a problem and an associated solution that was attempted for the purpose of resolving the problem,
receiving a classification system definition data set (CSDDS) that includes information indicative of a plurality of categories and/or sub-categories and relationships between the categories and/or sub-categories to define a classification system,
classifying, by machine logic, the plurality of problem-solution data sets according to the classification system to obtain a plurality of classified problem-solution data sets,
converting, by machine logic, the plurality of classified problem-solution records into a plurality of chatbot intent-entity records, and
inserting the plurality of chatbot intent-entity records into the chatbot type computer program to build and/or refine the chatbot, which chatbot is programmed and/or structured to chat with users about the problems included in the plurality of problem-solution data sets using the chatbot intent-entity records.

8. The CPP of claim 7 wherein the receipt of the plurality of problem-solution data sets from the knowledge base that is external to the chatbot reduces after-build testing because the knowledge base is external to the chatbot.

9. The CPP of claim 7 wherein the receipt of the CSDDS includes extracting the plurality of categories and/or sub-categories and relationships between the categories and/or sub-categories from the plurality of problem-solution records.

10. The CPP of claim 7 wherein the computer code further includes instructions for causing the processor(s) set to perform the following operation(s):
configuring a relational database to store information indicative the plurality of categories and/or sub-categories and relationships between the categories and/or sub-categories;
storing, in the relational database, the plurality of categories and/or sub-categories and relationships between the categories and/or sub-categories; and
cross-referencing, using information stored in the relational data base, the CSDSS with the plurality of problem-solution data sets.

11. The CPP of claim 10 wherein the conversion of the plurality of problem-solution records into the plurality of chatbot intent-entity records includes maintaining the cross-referencing between the following: (i) the plurality of categories and/or sub-categories and relationships between the categories and/or sub-categories, and (ii) the plurality of chatbot intent-entity data sets.

12. The CPP of claim 7 wherein the chatbot type computer program includes:
a user interface module structured and/or programmed to communicate information from and to the users of the chatbot;
a natural language parsing module structured and/or programmed to parse natural language pieces of text received from users during chats; and
a chat control logic module structured and/or programmed to match user inputs to corresponding chatbot intent-entity records and to generate natural language text for chats with users based, at least in part, upon the chatbot intent-entity data sets.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving, from the knowledge base, a plurality of problem-solution data sets with each problem-solution data set including information indicative of at least a problem and an associated solution that was attempted for the purpose of resolving the problem,
receiving a classification system definition data set (CSDDS) that includes information indicative of a plurality of categories and/or sub-categories and relationships between the categories and/or sub-categories to define a classification system,
classifying, by machine logic, the plurality of problem-solution data sets according to the classification system to obtain a plurality of classified problem-solution data sets,
converting, by machine logic, the plurality of classified problem-solution records into a plurality of chatbot intent-entity records, and
inserting the plurality of chatbot intent-entity records into the chatbot type computer program to build and/or refine the chatbot, which chatbot is programmed and/or structured to chat with users about the problems included in the plurality of problem-solution data sets using the chatbot intent-entity records.

14. The CS of claim 13 wherein the receipt of the plurality of problem-solution data sets from the knowledge base that is external to the chatbot reduces after-build testing because the knowledge base is external to the chatbot.

15. The CS of claim 13 wherein the receipt of the CSDDS includes extracting the plurality of categories and/or sub-categories and relationships between the categories and/or sub-categories from the plurality of problem-solution records.

16. The CS of claim 13 wherein the computer code further includes instructions for causing the processor(s) set to perform the following operation(s):
configuring a relational database to store information indicative the plurality of categories and/or sub-categories and relationships between the categories and/or sub-categories;
storing, in the relational database, the plurality of categories and/or sub-categories and relationships between the categories and/or sub-categories; and
cross-referencing, using information stored in the relational data base, the CSDSS with the plurality of problem-solution data sets.

17. The CS of claim 16 wherein the conversion of the plurality of problem-solution records into the plurality of chatbot intent-entity records includes maintaining the cross-referencing between the following: (i) the plurality of categories and/or sub-categories and relationships between the categories and/or sub-categories, and (ii) the plurality of chatbot intent-entity data sets.

18. The CS of claim 13 wherein the chatbot type computer program includes:
a user interface module structured and/or programmed to communicate information from and to the users of the chatbot;
a natural language parsing module structured and/or programmed to parse natural language pieces of text received from users during chats; and
a chat control logic module structured and/or programmed to match user inputs to corresponding chatbot intent-entity records and to generate natural language text for chats with users based, at least in part, upon the chatbot intent-entity data sets.
